(19) United States
(12) Patent Application Publication
(10) Pub. No.: US 2009/0300406 A1
(43) Pub. Date: Dec. 3, 2009

(54) INFORMATION PROCESSING SYSTEM AND INFORMATION PROCESSING DEVICE

(75) Inventor: Yousuke KATOU, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/475,481

(22) Filed: May 30, 2009

(30) Foreign Application Priority Data
May 30, 2008 (JP) 2008-141984

(51) Int. Cl. G06F 11/00; G06F 15/173; G06F 15/16

(52) U.S. Cl. 714/3; 714/47; 709/224; 709/203

(57) ABSTRACT

An information processing system includes a plurality of server devices including a main server device and at a standby server device, and a client device coupled to said server devices via a network. The client device includes a monitor unit to asynchronously monitor an operation state of each of the plurality of server devices, and a display control unit to acquire a content from the main server device and display the content in a display area on a screen once the monitor unit detects an operation state of the main server device is active, and to acquire from the standby server device a content for a process that the standby server device has taken over from the main server device and displays the content on the screen once the monitor unit detects an operation state of the standby server device is switched from standby state to active state.

### CROSS-REFERENCE TO RELATED APPLICATIONS

This application is based upon and claims the benefit of priority of the prior Japanese Patent Application No. 2008-141984, filed on May 30, 2008, the entire contents of which are incorporated herein by reference.

### FIELD

An aspect of the present invention relates to an information processing system, an information processing device and computer program thereof. One example of the aspect relates to a Web system that includes multiplexed Web server devices and Web client devices coupled to the server devices via a network.

Hereunder, as an example, a Web system will be described. However, this invention may be applied to systems other than the Web system.

### BACKGROUND

In a Web system that includes a Web server device and a Web client device, the Web client device that has a Web browser is coupled to the Web server device via a network such as the Internet. Such Web client device transmits, for example, a Hypertext Transfer Protocol (HTTP) request to the Web server device, and then displays a Hypertext Markup Language (HTML) content sent from the Web server device in response to the request on the Web browser.

This kind of Web system may be multiplexed by providing a main, or in-operation, server device and a standby, or a subsystem, server device with different IP addresses assigned respectively to achieve high reliability. Refer to Japanese Laid-open Patent Publication No. 2005-135125 and No. 2006-39662 for multiplexed Web server devices.

However, if a fault occurs, for example, at a main Web server in a Web system in which Web server devices are multiplexed as described the above, a Web client device may not receive a response from a Web server device while processing is taken over from the main Web server device to the standby Web server device. As a result, an error screen or a page may be displayed indicating a page may not be displayed. Moreover, there is a technical drawback that the error screen continues to be displayed until a user performs any operation such as clicking a button or a link on the Web browser of the client device.

### SUMMARY

According to an embodiment of the invention, an information processing system includes a plurality of server devices including a main server device and at a standby server device, and a client device coupled to said server devices via a network, wherein the client device includes a monitor unit to asynchronously monitor an operation state of each of the plurality of server devices, and a display control unit to acquire a content from the main server device and display the content in a display area on a screen once the monitor unit detects an operation state of the main server device is active, and to acquire from the standby server device a content for process that the standby server device has taken over from the main server device and displays the content on the screen once the monitor unit detects an operation state of the standby server device is switched from standby state to active state.

### BRIEF DESCRIPTION OF DRAWINGS

Embodiments are illustrated by way of example and not limited by the following figures.

FIG. 1 illustrates a configuration of a Web system according to an example of an embodiment of the present invention of the present invention;

FIG. 2 illustrates a frame structure of a Web browser of a client according to an example of an embodiment of the present invention;

FIG. 3 is a flow chart illustrating one example of an operation by a Web system according to an example of embodiment of the present invention; and

FIG. 4 is a flow chart illustrating other example of an operation by the Web system according to an example of an embodiment of the present invention.

### DESCRIPTION OF EMBODIMENTS

In the figures, dimensions and/or proportions may be exaggerated for clarity of illustration. It will also be understood that when an element is referred to as being “coupled to” another element, it may be directly connected or indirectly connected, i.e., intervening elements may also be present. Further, it will be understood that when an element is referred to as being “between” two elements, it may be the only element between the elements, or one or more intervening elements may also be present. Like reference numerals refer to like elements throughout.

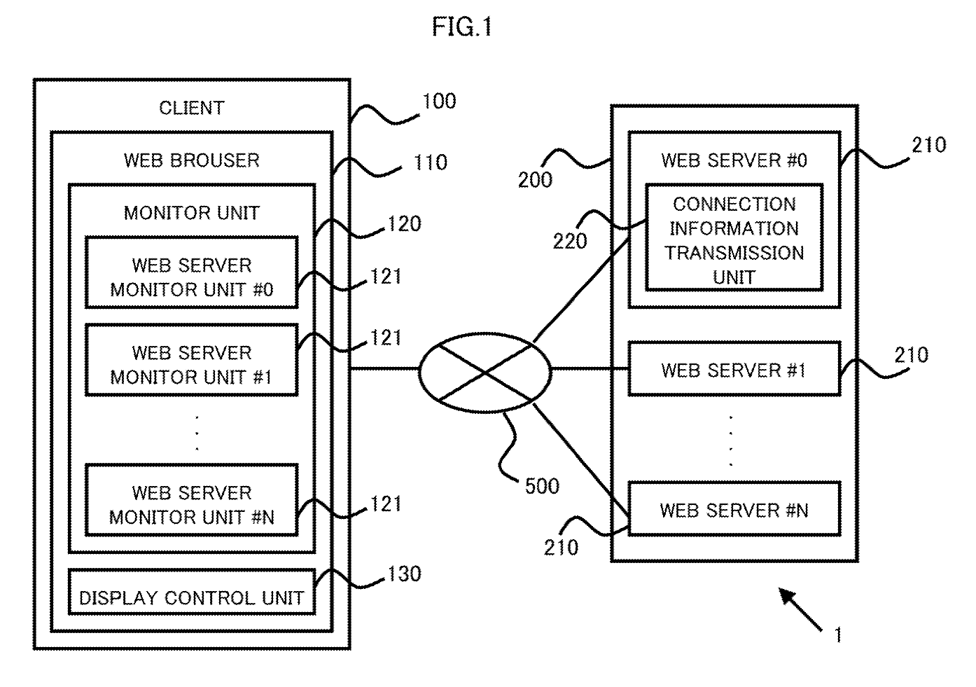

FIG. 1 illustrates a configuration of a Web system, wherein a Web system 1 provides a client 100 and a Web server system 200. The Web server system 200 is coupled to the client 100 via a network 500 such as the Internet. The Web system 1 may include two or more clients 100.

The client 100 is an example of a “Web client device” and a computer on which a Web browser 110 operates. The client 100 may display a content provided by the Web server system 200 on a screen (not illustrated) by a function of the Web browser 110.

The Web server system 200 includes a plurality of Web servers 210, and the Web servers 210 are multiplexed. An example of a Web server system 200 illustrated in FIG. 1 has the number of “n+1” (“n” is an integer 0 or more) Web servers 210. The plurality of Web servers 210-#n are an example of “Web server devices” and each of the Web servers 210 is a computer that may provide services to the client 100. The plurality of Web servers 210-#n include one Web server 210 set as a main Web server that is a Web server 210-#0, and the number of “N” (“N” is an integer 1 or more) Web servers 210 set as standby Web server(s) that is Web server 210-#1 . . . Web server 210-#N. Hereunder, an entire or a part of standby Web servers will be indicated as “Web server 210-#N.” If a fault occurs at a Web server 210-#n operating as a main server, the Web server system 200 shifts processing, processing for a Common Gateway Interface (CGI) program or a user authentication for example, from the Web server 210-#n that operates as a main server to one of Web servers 210-#N that operate as standby servers. Each of Web servers 210-#n may notify own state, “active” indicating in operation or “standby” indicating in standby state, to the client 100 in response to a request from the client 100. In other words, a Web server 210-#0 operating as a main system Web server transmits a signal indicating “active” to the client 100 in response to a request from the client 100. Moreover, each of Web servers 210-#n operating as standby Web servers transmits a signal indicating “standby” to the client 100 in response to a request from the client 100.

In an initial state, a state of a Web server 210-#0 that is set as a main Web server is “active”, while a state of Web servers 210-#1 to 210-#N that are set as standby servers are “standby.”

Among a plurality of Web servers 210-#n, a Web server 210-#0 that is set as a main Web server includes a connection information transmission unit 220. When the Web server 210-#0 is accessed by the client 100, the connection information transmission unit 220 transmits connection information on other Web servers, that are Web servers 210-#1 to 210-#N, including information on URL of each Web server 210-#N to the client 100. This allows the client 100 to asynchronously communicate with each of a plurality of Web servers 210 that are Web servers 210-#0 to 210-#N respectively and to monitor operation states of a plurality of Web servers 210-#n by a monitor unit 120. The monitor unit 120 will be described later.

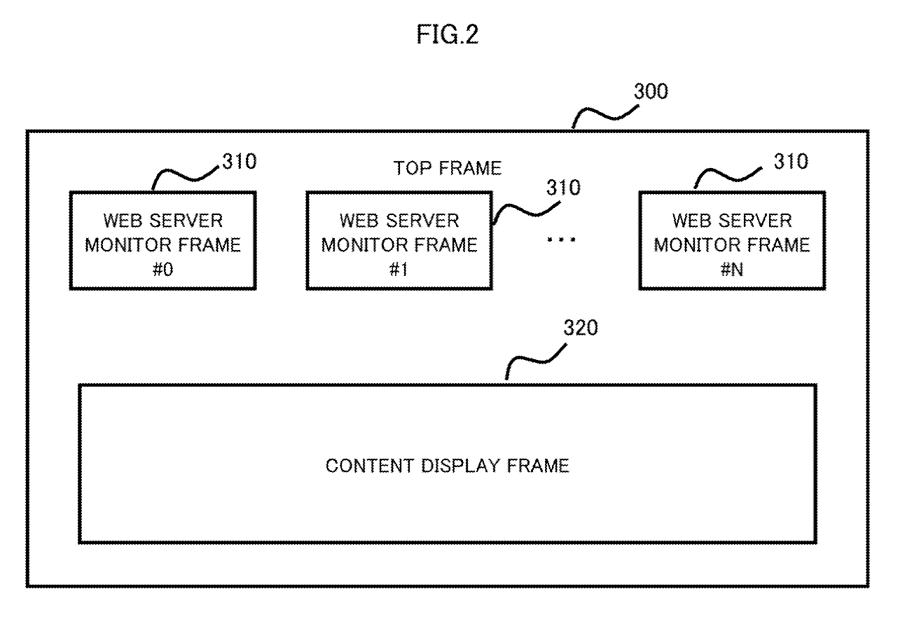

A configuration of a client will be described in detail by referring to FIG. 2 in addition to FIG. 1.

As illustrated in FIG. 1, a client 100 includes a monitor unit 120 and a display control unit 130.

The monitor unit 120 includes a plurality of Web server monitor units 121-#n provided for each of a plurality of Web servers 210-#n. The plurality of Web server monitor units 121 include a Web server monitor unit 121-#0, a Web server monitor unit 121-#1, . . . , a Web server monitor unit 121-#N provided for each of the number of (N+1) Web servers 210 that are Web servers 210-#0 to 210-#N. Each Web server monitor unit 121-#n is made up of a program written by a script language such as JavaScript (registered trademark) operating on the Web browser 110.

Each Web server monitor unit 121-#n may monitor an operation state of a corresponding Web server 210-#n by asynchronously communicating with the Web server 210-#n, by using, for example, an XML Http request in Ajax. Accordingly, the Web server monitor unit 121-#0 may monitor an operation state of the Web server 210-#1, and the Web server monitor unit 121-#N may monitor an operation state of the Web server 210-#N. For example, a Web server monitor unit 121-# k (k=0,1, . . . , N) transmits a request asking for a notification of an operation state of a corresponding Web server every given time to a Web server 210-# k by using, for example, an XML Http request. This allows the Web server monitor unit 121-# k to receive a signal indicating a state of each Web server 210-# k that is “active” or “standby” from the Web server 210-# k.

Moreover, each Web server monitor unit 121-#n may monitor a communication state between a corresponding Web server 210-#n and the client 100 by asynchronously communicating with the corresponding Web server 210-#n by using, for example, an XML Http request. For example, the Web server monitor unit 121-# k (k=0,1, . . . ,N) transmits a request asking for an operation state of the Web server 210-# k every given time or periodically to the Web server 210-# k by using, for example, an XML Http request. The Web server monitor unit 121-# k detects that the communication state of the Web server 210-# k is “communication possible” if the unit 121-# k receives a signal indicating the operation state from the Web server 210-# k. On the other hand, the Web server monitor unit 212-# k detects that the communication state of the Web server 210-# k is “communication impossible” if the Web server monitor unit 212-# k receives no signal that indicates the operation state from the Web server 210-# k even a given period passes after sending the request.

The display control unit 130 acquires a content from the Web server system 200, associates the acquired content with a content display frame 320 described later with reference to FIG. 2 and then display the content. The display control unit 130 acquires a content from a Web server 210-#0 and displays the acquired content in the content display frame 320 on the Web browser 110, if the monitor unit 120 detects that the operation state of the Web server 210-#0 that is set as a main Web server is “active.” Moreover, if the monitor unit 120 detects that an operation state of any of Web servers 210-#1 to 210-#N that are set as standby Web servers is changed from “standby” to “active”, the display control unit 130 acquires, from a Web server 210-#N the operation state of which is switched from “standby” to “active”, a content for processing taken over from the Web server 210-#0, and then displays the acquired content in the content display frame 320. The display control unit 130 is made up of a program written by a script language such as JavaScript (registered trademark) operating on the Web browser 110.

FIG. 2 illustrates a frame structure of a Web browser. As illustrated, a TOP frame 300 is displayed on the Web browser 110, that is an user interface (UI) of the client 100. The TOP frame 300 is divided into (N+2) frames that are made up of (N+1) frames for Web server monitor frames 310 and one frame for a content display frame 320. Note that the number of frames for Web server monitor frames 310 and the content display frame 320 set on the TOP frame 300 are not limited to those numbers illustrated in FIG. 2, and may be divided into (N+3) or more frames that include (N+1) Web server monitor frames 310 and one content display frame 320.

For (N+1) Web server monitor frames 310, that are a Web server monitor frame 310-#0, a Web server monitor frame 310-#1, . . . , a Web server monitor frame 310-#N illustrated in FIG. 2, the above described (N+1) Web server monitor units 121-#n are operated respectively. In other words, the Web server monitor unit 121-#0 operates in the Web server monitor frame 310-#0, the Web server monitor unit 121-#n operates in the Web server monitor frame 310-#1, and the Web server monitor unit 121-#N operates in the Web server monitor frame 310-#N respectively. For each Web server monitor frame 310-#n, a corresponding Web server monitor unit 121-#n made up of a script language such as JavaScript (registered trade mark) is assigned. A plurality of Web server monitor units 121-#n operates in different Web server monitor frames 310-#n. Thus, even if a plurality of Web servers 210 belong to different network domains, each of Web server monitor units 121-#n may communicate with the corresponding Web servers 210-#n respectively.

Moreover, each Web server monitor frame 310-#n is set as a frame with a height of “0” respectively so that a user may not visually recognize the frame. Thus, the Web server monitor unit 121-#n may monitor the Web server 210-#n without making a user visually recognize the Web server monitor unit 121-#n is operating in the Web server monitor frame 310-#n. Each Web server monitor frame 310-#n may be set as a frame with a given height so that a user may visually recognize the frame. This allows a user to recognize an operation or a communication state of the Web server 210-#n monitored by the Web server monitor unit 121-#n.

The content display frame 320 is a frame for displaying a content acquired from the Web server system 200 by the display control unit 130.

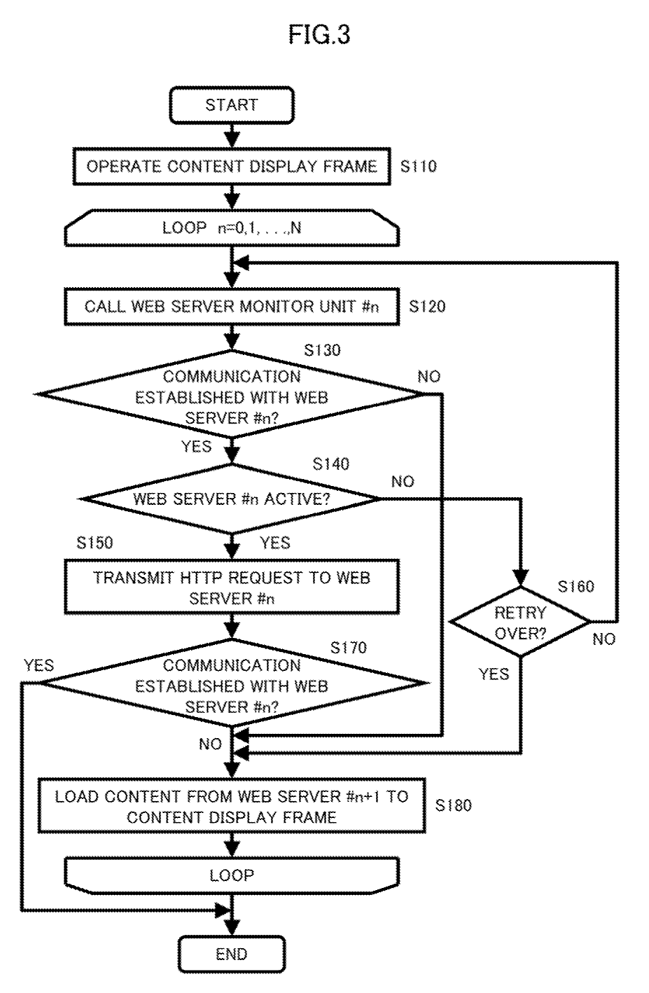

One example of an operation by a Web system configured as the above will be described by referring to FIG. 3.

FIG. 3 is a flow chart illustrating one example of an operation by a Web system.

FIG. 3 illustrates one example of an operation by a Web system 1 when a user operates a content, for example, by clicking a button or a link displayed as a content in a content display unit 320 described by referring to FIG. 2.

In FIG. 3, when a user operates a content displayed in a content display frame 320 (S110), one of Web server monitor units 121-#n is called (S120). In an example of FIG.3, first, a Web server monitor unit 121-#n is called (S120). In other words, a user operation calls a Web server monitor unit 121-#0 that is made up of a program written by a script language such as JavaScript (registered trade mark) and assigned to a Web server monitor frame 310-#0. Note that every time “loop” processing illustrated in FIG. 3 is executed, Web server monitor units 121-#n+1 are sequentially called. The loop processing in FIG. 3 is repeated and every time Web server 121-#n+1 is sequentially called until it is judged that one of Web server monitor units 121-#0 to 121-#N may communicate with one of Web servers 210-#0 to 210-#N by processing of S170 described later.

Then, the Web server monitor unit 121-#n judges whether or not communication is established with the corresponding Web server 210-#n (S130). Accordingly, the Web server monitor unit 121-#n detects a communication state of the Web server 210-#n that is “communication possible” or “communication impossible.”

If the Web server monitor unit 121-#n judges that communication is not established with the Web server 210-#n (S130: No), processing for loading a content from the Web server 210-#n+1 to the content display frame 320 is performed (S180). In this case, the processing returns to S120, and the Web server monitor unit 121-#n+1 is called (S120), as indicated by the “Loop” blocks in FIG. 3. If the Web server monitor unit 121-#n detects communication with the Web server 210-#n is not established, in other words, a fault occurs at the Web server 210-#n, a Web server monitor unit 121-#n+1 is called in order to judge whether or not a content may be acquired from Web server 210-#n+1 that is set as a standby server (S120).

If the Web server monitor unit 121-#n judges that communication with the Web server 210-#n is established (S130: YES), the unit 121-#n further judges whether the Web server 210-#n is “active” or “standby” (S140). In other words, the Web server monitor unit 121-#n detects that whether an operation state of the Web server 210-#n is “active” or “standby.”

If the Web server monitor unit 121-#n judges that the Web server 210-#n is not “active” (S140: NO), then the unit 121-#n judges whether or not the condition is retry over (S160). In other words, the Web server monitor unit 121-#n judges whether or not a state that the Web server 210-#n is not “active” lasted for a given time at S140. If the Web server monitor unit 121-#n judges that it is not retry over (S160: NO), processing of S120 is executed again. If the Web server monitor unit 121-#n judges that it is retry over (S160: YES), processing for loading a content from a Web server 210-#n+1 to the content display frame 320 is performed (S180), and a Web server monitor unit 210-#n+1 is called (S120). This means, if the Web server monitor unit 121-#n detects an operation state of the Web server 210-#n has not been “active” for a given period, in other words, a fault occurs at the Web server 210-#n, a Web server monitor unit 121-#n+1 corresponding to the Web server 210-#n+1 is called in order to judge whether or not a content may be acquired from the Web server 210-#n+1 that is set as a standby server (S120).

If the Web server monitor unit 121-#n judges that the state of the Web server 210-#n is “active” (S140: YES), the client 100 transmits a HTTP request to the Web server 210-#n (S150). Accordingly, the client 100 transmits a HTTP request corresponds to a user operation for a content displayed in the content display frame 320 to a Web server 210-#n the operation state of which is “active.”

Then, the Web server monitor unit 121-#n judges that whether or not the client 100 may communicate with the Web server 210-#n (S170) as a result of transmitting the HTTP request to the Web server 210-#n. In other words, the Web server monitor unit 121-#n judges that whether or not a content in response to the HTTP request corresponds to the user operation is received from the Web server 210-#n. If the client 100 may communicate with the Web server 210-#n (S170: YES), the content received from the Web server 210-#n is displayed in the content display frame 320 by the display control unit 130. This completes the processing for the user operation to a content displayed in the content display frame 320.

If the client 100 may not communicate with the Web server 210-#n (S170: NO), the processing returns to S120 in order to execute processing for loading a content from the Web server 210-#n+1 to the content display frame 320 (S180), and then the Web server monitor unit 121-#n+1 is called (S120). Accordingly, if the client 100 may not communicate with the Web server 210-#n, in other words, if the Web server monitor unit 121-#n detects a fault occurs at the Web server 210-#n, the Web server monitor unit 121-#n+1 is called in order to judge whether or not the content may be acquired from the Web server 210-#n+1.

As described above, when a user operates a content displayed in the content display frame 320, the Web server monitor units 121-#0 to 210-#N are sequentially called until the client 100 may communicate with one of the Web server monitor units 121-#0 to 121-#N. This allows the client 100 to receive a content from a Web server 210-#N the state of which is “active” among (N+1) Web servers 210-n. Thus, if a fault occurs at a Web server 210-#0 that is set as a main server, a content for the processing taken over to one of the number of “N” standby Web servers 210 that are Web servers #1 to #N, may be acquired from the Web server that has taken over the processing and displayed in the content display frame 320. This means that a content for the processing taken over from the Web server 210-#0 that is set as main Web server to the Web server 210-#N that is set as a standby Web server may be seamlessly displayed on the client 100. Thus, the display in the content display frame 320 may be seamlessly updated with a content acquired from the Web server 210-#N to which the processing is taken over without any reload or update operation by a user. As a result, a situation in which an error screen is displayed on the Web browser 110 may be avoided, even if no response is obtained from the Web server 210-#0 that is set as a main Web server. Or even if an error screen is displayed on the Web browser 110 due to no response is obtained from the Web server 210-#0 that is set as a main Web server, a situation in which the error screen is continuously displayed on the Web browser 110 may be avoided. Thus, a user of the client 100 rarely aware or almost totally unaware of a fault occurs at the Web server 210-#0 that is set as a main Web server, and may continue to use a content displayed on the Web browser 110. Moreover, taking over user authentication information from the Web server 210-#0 that is set as a main Web server to the Web server 210-#N that is set as a standby Web server enables the user of the client 100 to continuously use the content displayed on the Web browser 110 without any authentication operation by the user for the Web server 210-#N that takes over the processing.

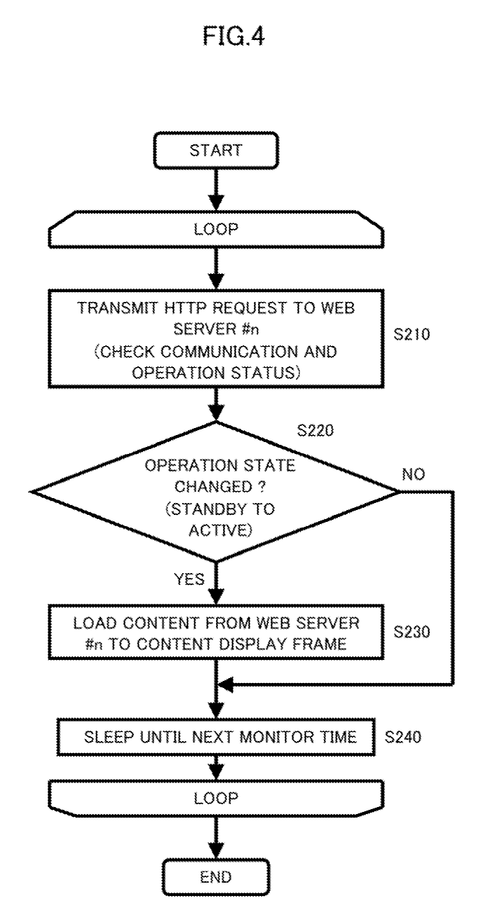

Now, other example of the above described operation of the Web system will be explained by referring to FIG. 4.

FIG. 4 is a flow chart illustrating other example of an operation by a Web system.

FIG. 4 illustrates one example of an operation of the Web system while a user does not operate a content displayed in a content display frame 320 described by referring to FIG. 2.

In FIG. 4, a Web server monitor unit 121-#n (n=1 . . . N) transmits a HTTP request to a corresponding Web server 210-#n (S210). This means that each Web server monitor unit 121-#n transmits a request for detecting an operation and a communication state of the Web server 210-#n to Web servers 210-#n other than the corresponding main Web server 210-#0 by using an XML Http request in Ajax.

Then, the corresponding Web server monitor unit 121-#n judges whether or not an operation state of the Web server 210-#N is changed from “standby” to “active” (S220). In other words, the Web server monitor unit 121-#n judges whether or not the processing is taken over from the Web server 210-#0 that is set as a main Web server to the Web server 210-#N.

If the Web server monitor unit 121-#n judges that the operation state of the Web server 210-#0 is not changed from “standby” to “active”, for example, if an operation state of a Web server 210-#n that is set as a standby Web server remains to be “standby” or a Web server 210-#0 that is set as a main Web server is remains to be “active” (S220:NO), a Web server monitor unit 121-#n stops operation for a given period, or sleeps until the next monitor time (S240), and then transmits a HTTP request to the Web server 210-#n again (S210), as indicated by the “Loop” blocks in FIG. 4. Thus, the Web server monitor unit 112-#n monitors an operation state of the corresponding Web server 210-#n by asynchronous communication.

If the Web server monitor unit 121-#n judges that the operation state of the Web server 210-#n is changed from “standby” to “active” (S220: NO), a content is loaded from a Web server 210-#n with “active” state to the content display frame 320 (S230: YES). Accordingly, if the Web server monitor unit 121-#n detects the processing is taken over from the Web server 210-#0 that is set as a main Web server to the Web server 210-#n, the display control unit 130 displays a content acquired from the Web server 210-#n that takes over the processing from the Web server 210-#0.

As described the above, each Web server monitor unit 121-#n monitors an operation or communication state of the corresponding Web server 210-#n by performing asynchronous communication with the corresponding Web server 210-#n. Furthermore, if the Web server monitor unit 210-#N judges that the operation state of the Web server 210-#N is changed from “standby” to “active”, the display control unit 130 acquires a content from the Web server 210-#N the operation state of which is changed from “standby” to “active”, and displays the content in the content display frame 320. Thus, a content for processing that is taken over to the standby Web server 210-#N may be seamlessly displayed. As a result, a situation in which an error screen is displayed on the Web browser 110 may be avoided, even if no response is obtained from the main Web server 210-#0. Or even if an error screen is displayed on the Web browser 110 due to no response is obtained from the main Web server 210-#0, a situation in which an error screen is continuously displayed on the Web browser 110 may be avoided. Thus, a user of the client 100 rarely aware or almost totally unaware of a fault occurs at the main Web server 210-#0, and may continue to use a content displayed on the Web browser 110.

As one example of modification, if a fault occurs at a main Web server, the display control unit 130 may display a message informing that a processing is being taken over from a main Web server to a standby Web server during the processing. For example, in FIG. 4, each Web server monitor unit 121-#n transmits a request for detecting an operation or a communication state of a corresponding Web server 210-#n. If the monitor unit 120 detects a communication state of between a client 100 and a main Web server 210-#0 is “communication impossible” and all of standby Web servers 210-#n (Web server #1 to #N) are “standby” as well, the display control unit 130 may be configured so as to display a message in the content display frame 320 that indicates processing is being taken over from the main Web server to a standby Web server. For example, following message may be displayed, “Please wait for a moment. Now processing is being taken over to a standby server.” In this way, a user of the client 100 may recognize processing is being taken over from the main Web server 210-#0 to the standby Web server 210-#N. This may reduce a sense of uncertainty by the user of the client 100 such as “what is happening now?”

As described the above, according to the Web system of the embodiment, displaying an error screen on a client while processing is being taken over from a main server to a standby server may be reduced, and a content may be displayed continuously.

Examples of embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made therein without departing from the spirit and scope of the present invention as set forth in the claims.

What is claimed is:

1. An information processing system comprising:
a plurality of server devices including a main server device and at least a standby server device; and
a client device coupled to said server devices via a network;
wherein the client device comprising:
a monitor unit to asynchronously monitor an operation state of each of the plurality of server devices; and
a display control unit to acquire a content from the main server device and display the content in a display area on a screen once the monitor unit detects an operation state of the main server device is active, and to acquire from the standby server device a content for a process that the standby server device has taken over from the main server device and displays the content on the screen once the monitor unit detects an operation state of the standby server device is switched from standby state to active state.

2. An information processing system according to claim 1, wherein the monitor unit to asynchronously monitor communication states between the client device and the plurality of server devices with the operation state of a corresponding server device, and
the display control unit to display a message indicating that the process is being taken over from the main server to the standby server on the screen once the monitor unit detects a lack of communication between the client device and the main server device and all of standby servers are in standby state.

3. An information processing system according to claim 1, wherein the monitor unit includes a plurality of server monitor units each assigned to one of a plurality of frames, each of the frame is set for one of the plurality of server devices, and each of the plurality of server monitor units to monitor an operation state of the corresponding server device respectively.

4. An information processing apparatus coupled to a plurality of server devices via a network comprising:
a plurality of monitor units provided for each of the plurality of server devices, each the monitor units to monitor an operation state of the corresponding server device; and
a display control unit to acquire a content from the server device, and displays the content on a display screen once any of the monitor unit detects that a corresponding server device among the plurality of server devices is in an active state,
the display control unit to further acquire the content from a server device in which the operation state is changed from a standby state to a active state, and displays the content acquired from the server device in which the operation state is changed to the active state when an operation state of any of the server device is switched from the standby state to the active state.

5. A computer readable medium that stores computer program that controls a computer in an information processing system communicates with a plurality of server devices, the server devices include a main server device and a standby server that takes over a process from the main server device, the computer program causing the computer to function as:
a monitor unit to monitor an operation state of each of the plurality of server devices by asynchronously communicating with each of the server devices; and
a display control unit to acquire a content from the main server device and displaying the content acquired from the main server device in a display area on a screen of the computer when the monitor unit detects that the main server device is in an active state, and for acquiring from the standby server device a content for process taken over from main server device and displaying the content acquired from the standby server when the monitor unit detects that the standby server device is switched from a standby state to an active state.
